(19) United States
(12) Patent Application Publication
(10) Pub. No.: US 2017/0211364 A1
(43) Pub. Date: Jul. 27, 2017

(54) KINETIC ENERGY MONITORING FOR A PLUNGER LIFT SYSTEM

(71) Applicant: Extreme Telematics Corp., Calgary (CA)

(72) Inventor: Mark David Scantlebury, Calgary (CA)

(21) Appl. No.: 15/415,742

(22) Filed: Jan. 25, 2017

(30) Foreign Application Priority Data
Jan. 26, 2016 (CA) 2918978

(51) Int. Cl. E21B 43/12; G05B 15/02; G01P 3/00; E21B 47/00; G01L 5/00

(52) U.S. Cl. CPC E21B 43/122; E21B 47/0007; G01L 5/0095; G01L 5/0061; G01P 3/00; G05B 15/02

(57) ABSTRACT

In an aspect, a method of operating a plunger lift system, a controller and a plunger lift system in a well is provided. The velocity of a plunger is measured by a velocity sensor positioned proximate a top of the well when the plunger passes the velocity sensor. The measured velocity can then be used to determine a kinetic energy of the plunger as it passed the velocity sensor. Each time the plunger passes the velocity sensors, the kinetic energy of the plunger can be determined. This determined kinetic energy can then be used to determine if the well should be shut down or if portions of the plunger lift system should be replaced.

The invention relates to the control of an oil and gas well using a plunger lift device and more particularly to an apparatus and method for identifying and dealing with potentially damaging impacts of the plunger on the top of the well and for determining when to perform maintenance on the plunger lift system.

### BACKGROUND

A plunger lift is an artificial lift method that is used to remove fluids from a gas well. A plunger lift system uses a freely moving plunger in the production tubing. A seal is formed between the plunger and the production tubing that prevents fluid from passing between the plunger and the wall of the production tubing. The plunger is allowed to sit at the bottom of the well until sufficient pressure builds up behind the plunger and then the plunger is allowed to rise to the top of the well. Fluid that has accumulated on top of the plunger is carried up the well by the plunger to the wellhead, where this fluid is then removed from the well.

The movement of the plunger is controlled by opening and closing a valve between the production tubing and an outlet line (commonly called a sales line). When the valve is closed, the plunger drops to the bottom of the well. With the valve closed, the pressure from the well builds up and when a desired pressure level is reached, the valve can be opened, connecting the production tubing with the outlet line. Because the outline line is typically at a lower pressure than the elevated pressure in the production tubing, the gas in the production tubing flows out of the well through the open valve and into the outlet line. This causes the plunger to rise in the well. When the plunger rises into the wellhead, it can then remain in the wellhead until the gas exiting the production well through the open valve is sufficiently reduced and the plunger can then fall back down the production tubing.

The time the plunger is held in the wellhead and the valve is left open is called the “afterflow” time. This afterflow time is the time that gas is being produced from the well by allowing it to leave the well and enter the outlet line. However, having too large of an afterflow time can cause too much water to enter the well casing causing the well to “water in”. This can occur when the buildup of water in the well causes a hydrostatic barrier preventing gas from the formation from exiting the well. Over time, as more and more water is removed from the well casing by the plunger, the afterflow time may be able to be lengthened.

Typically, electronic controllers are used to control the operation of the plunger lift system. The electronic controller is used to control the opening and closing of the valve based on an afterflow time and a close time. Typically, these plunger lift systems will have a plunger arrival sensor positioned near the top of the well (usually in a plunger receiver in the wellhead) that can sense when the plunger has reached the top of the well and newer systems can even have a velocity sensor that can measure the velocity of the plunger.

In some of these systems the controller will not only control the opening and closing of a valve that determines the afterflow time and the close time but can also alter the afterflow time and/or close time to try and improve the performance of the plunger lift system.

However, while the electronic controller is controlling the afterflow and close time and possibly adjusting these time to try and improve the performance of the plunger lift system, the velocity of the plunger as it reaches the top of the well may not be of primary importance to the control of the plunger lift system because the quicker the rise time of the plunger the less time is wasted between times when gas is being produced from the well. Additionally, the controller is often more concerned with the time it takes the plunger to rise up the entire length of the well rather than how fast the plunger is moving at just the very top of the well. However, if the plunger arrives at the top of the well too fast, the plunger can damage the wellhead.

The rise time alone is not a good indicator of how fast the plunger may be travelling when it reaches the top of the well because the velocity of the plunger can vary greatly as it travels up the well. For example, the plunger could be traveling much slower at the bottom of the well because it is just starting to move and will pick up speed as it continues to rise up the well. Additionally, the plunger may be picking up speed throughout its entire trip up the well and may be travelling faster at the top of the well than its average velocity during its trip up the well. This acceleration of the plunger could be due to a number of factors, such as the loss of fluid from above the plunger, decompressing of the gas, a hole in the tubing, fluids unloading above the plunger down the sales line, etc. Therefore, even if the controller is determining that the time it is taking the plunger to rise up the well is perfectly reasonable, it does not necessarily mean that the plunger is not picking up speed near the top of the well and arriving in the plunger receiver at a dangerously fast speed that can damage the wellhead.

However, the velocity of the plunger as it reaches the top of the well alone is not the best indicator of the potential for damage to the top of the wellhead because different wellheads will have different strengths and be able to handle different impacts and plungers can vary significantly in weight causing different plungers to impact the wellhead with different forces even if they are travelling at the same velocity. One strategy that is used to deal with this is just try to keep the plunger below a velocity at the top of the well that is sufficiently low to be suitable for most plungers and wellheads. However, by doing this the safety margin that is built it to accommodate relatively heavy plungers and relatively weak wellheads can cause the controller to not allow the plunger lift system to operate as efficiently as if it could if this surface velocity was higher and the higher surface velocity might be perfectly safe for lighter plungers and/or a stronger wellhead.

### SUMMARY

In an aspect, a method of operating a plunger lift system in a well is provided. The method includes in response to a plunger passing a velocity sensor positioned proximate a top of the well, measuring a plunger velocity using the velocity sensor, using the measured plunger velocity to determine a kinetic energy of the plunger as it passes the velocity sensor, if the determined kinetic energy of the plunger exceeds a dangerous trip threshold, shutting down the plunger lift system, and repeating the steps of the method each time the plunger passes the velocity sensor.

In another aspect, a controller for controlling the operation of a plunger lift system for a well having a plunger, a plunger velocity sensor, and a control valve between the well and an outlet line is provided. The controller includes at least one processing unit, an input interface operatively connectable to the plunger velocity sensor and at least one memory containing program instructions. The at least one processing unit responsive to the program instructions and operative to perform a method of in response to the plunger passing the velocity sensor positioned proximate a top of the well, measuring a plunger velocity using the velocity sensor, using the measured plunger velocity to determine a kinetic energy of the plunger as it passes the velocity sensor, if the determined kinetic energy of the plunger exceeds a dangerous trip threshold, shutting down the plunger lift system, and repeating the steps of the method each time the plunger passes the velocity sensor.

In another aspect, a plunger lift system for removing fluids from a well is provided. The system includes a wellhead provided at a top of the well and having a plunger receiver, a production tubing connected to the well head and extending downwards down the well, the plunger receiver operatively connected to a top end of the production tubing, a plunger provided in the production tubing, an outlet line connected to the well head below the plunger receiver and fluidly connected with the production tubing, a control valve connected inline with the outlet line, a plunger velocity sensor positioned on the outside of the plunger receiver to detect the plunger and a controller operatively connected to the plunger velocity sensor to receive information from the plunger velocity sensor and operatively connected to the control valve to open and close the control valve. The controller is operative to perform the method of opening a control valve and allowing the plunger to rise to a top of the well, in response to the plunger passing the velocity sensor positioned proximate a top of the well, measuring a plunger velocity using the velocity sensor, using the measured plunger velocity to determine a kinetic energy of the plunger as it passes the velocity sensor, after an afterflow time has passed closing the valve and allowing the plunger to fall to a bottom of the well, after a period of time has passed, opening the valve and allowing the plunger to rise to the top of the well, if the determined kinetic energy of the plunger exceeds a dangerous trip threshold, shutting down the plunger lift system, and repeating the steps of the method each time the plunger passes the velocity sensor.

In another aspect, a method of determining kinetic energy in a plunger lift system in a well is provided. The method includes in response to a plunger passing a velocity sensor positioned proximate a top of the well, measuring a plunger velocity using the velocity sensor and using the measured plunger velocity to determine a kinetic energy of the plunger as it passes the velocity sensor.

In another aspect, a method of operating a plunger lift system in a well is provided. The method includes measuring a velocity of a plunger using a velocity sensor positioned proximate a top of the well, using the measured velocity of the plunger to determine a kinetic energy of the plunger as it passes the velocity sensor, repeating the steps of the method when the plunger is once again measured passing the velocity sensor and each time the plunger passes the velocity sensor and a kinetic energy of the plunger is determined, summing the kinetic energy to determine a current kinetic energy sum so that when the current kinetic energy sum is greater or equal to a lifetime rating, replace an impact absorber in a well head of the plunger lift system.

In another aspect, a controller for controlling the operation of a plunger lift system for a well having a plunger, a plunger velocity sensor, and a control valve between the well and an outlet line is provided. The controller has at least one processing unit, an input interface operatively connectable to the plunger velocity sensor and at least one memory containing program instructions. The at least one processing unit responsive to the program instructions and operative to perform a method of measuring a velocity of a plunger using a velocity sensor positioned proximate a top of the well, using the measured velocity of the plunger to determine a kinetic energy of the plunger as it passes the velocity sensor, repeating the steps of the method when the plunger is once again measured passing the velocity sensor, each time the plunger passes the velocity sensor and a kinetic energy of the plunger is determined, summing the kinetic energy to determine a current kinetic energy sum and when the current kinetic energy sum is greater or equal to a lifetime rating, creating a signal that indicates replacing an impact absorber in a well head of the plunger lift system.

In another aspect, a plunger lift system for removing fluids from a well is provided. The system includes a wellhead provided at a top of the well and having a plunger receiver, the plunger receiving having an impact absorber, production tubing connected to the well head and extending downwards down the well, the plunger receiver operatively connected to a top end of the production tubing, a plunger provided in the production tubing, an outlet line connected to the well head below the plunger receiver and fluidly connected with the production tubing, a control valve connected inline with the outlet line, a plunger velocity sensor positioned on the outside of the plunger receiver to detect the plunger and a controller operatively connected to the plunger velocity sensor to receive information from the plunger velocity sensor and operatively connected to the control valve to open and close the control valve. The controller operative to perform a method of opening a control valve and allowing the plunger to rise to a top of the well, in response to the plunger passing the velocity sensor positioned proximate a top of the well, measuring a plunger velocity using the velocity sensor, using the measured plunger velocity to determine a kinetic energy of the plunger as it passes the velocity sensor, after an afterflow time has passed closing the valve and allowing the plunger to fall to a bottom of the well, after a period of time has passed, opening the valve and allowing the plunger to rise to the top of the well, repeating the steps of the method when the plunger is once again measured passing the velocity sensor, each time the plunger passes the velocity sensor and a kinetic energy of the plunger is determined, summing the kinetic energy to determine a current kinetic energy sum and when the current kinetic energy sum is greater or equal to a lifetime rating, creating a signal that indicates replacing the impact absorber.

### BRIEF DESCRIPTION OF THE DRAWINGS

A preferred embodiment of the present invention is described below with reference to the accompanying drawings, in which:

FIG. 1 illustrates a plunger lift system;

FIG. 2 is a state diagram showing the two modes of operation of the plunger lift system;

FIG. 3 is a schematic illustration of a controller used in the plunger lift system;

FIG. 4 is a flowchart of a method for dealing with potentially damaging plunger strikes; and

FIG. 5 is a flowchart of a method of approximating the amount of kinetic energy that has been absorbed by an impact absorber in the plunger lift system to determine when to replace the impact absorber.

### DETAILED DESCRIPTION OF THE ILLUSTRATED EMBODIMENTS

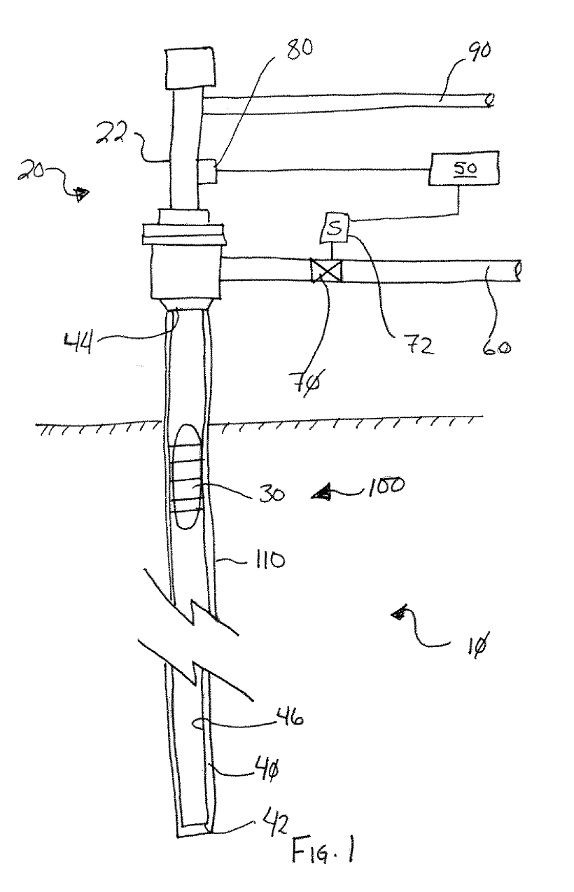

FIG. 1 illustrates a plunger lift system 10 for removing fluids from a well 100. The plunger lift system 10 can include: a wellhead 20: a plunger 30; production tubing 40; a controller 50; an outlet line 60; a control valve 70; a velocity sensor 80; a discharge line 90; and other equipment for the operation of the plunger lift system 10.

The well 100 is typically provided with a well casing 110. Production tubing 40 can be provided running down the well casing 110 between the wellhead 20 and the bottom 42 of the production tubing 40.

The plunger 30 can be provided in the production tubing 40 so that the plunger 30 is able to move up and down in the production tubing 40. The plunger 30 can form a seal with the wall 46 of the production tubing 40 to prevent significant amounts of fluids from passing around the plunger 30 between the outside of the plunger 30 and the wall 46 of the production tubing 40.

The wellhead 20 can be provided at a top of the well casing 110 and the production tubing 40. The wellhead 20 can fluidly connect the production tubing 40 and the well casing 110 to the outlet line 60. The outlet line 60 routes gas out of the well 100 for transport or collection. A control valve 70 can be provided between the outlet line 60 and the well 100.

The wellhead 20 can include a plunger receiver 22 operatively connected to a top end 44 of the production tubing 40 and above where the outlet line 60 is connected. At the top of its travel, the plunger 30 can enter the plunger receiver 22 and be held in place in the plunger receiver 22 entirely above where the outlet line 60 connects with the well 100. Alternatively, the plunger receiver 22 can be configured so that the pressure of the gas being produced from the well 100 will hold the plunger 30 at the top of the well 100 and in the plunger receiver 22 with the plunger 30 just bouncing at the top of the well 100, rather than the plunger 30 being physically held in the plunger receiver 22.

A velocity sensor 80 can be positioned on the outside of the plunger receiver 22 so that the plunger 30 will pass by the velocity sensor 80 when the plunger 30 enters the plunger receiver 22 and the velocity sensor 80 can approximate a velocity of the passing plunger 30.

A discharge line 90 can be connected to the plunger receiver 22 so that fluids pushed into the plunger receiver 22 by the plunger 30 can be removed from the plunger receiver 22. In some cases, these fluids may be routed through a separator (not shown) so that unwanted liquids and other contaminants can be removed from the plunger receiver 22. If the plunger lift system 10 is being used to produce oil (or other saleable liquids) from the well 100, the oil is discharged out of the plunger lift system 10 through this discharge line 90.

Referring to FIG. 2, the plunger lift system 10 alternates between an open cycle 201 (or production cycle) where the control valve 70 is opened and gas is flowing out of the well 100 through the outlet line 60 and a closed cycle 203 (or shut in cycle) where the control valve 70 is closed and gas is prevented from flowing out of the well 100 into the outlet line 60 allowing the pressure in the well 100 to increase. A first trigger 205 will cause the plunger lift system 10 to change from operating in the open cycle 201 to operating in the closed cycle 203 and a second trigger 207 will cause it to move from the closed cycle 203 to the open cycle 201. Typically, this first trigger 205 is the closing of the valve 70 and the second trigger 207 is an opening of the valve 70.

During the closed cycle 203, when the control valve 70 is closed and gas cannot flow out of the well 100 to the outlet line 60, the plunger 30 can drop down the well 100 to a position proximate the bottom of the well 100. When the closed cycle 203 is finished and the control valve 70 is opened, pressure that has built up in the well 100 causes the plunger 30 to rise up the production tubing 40 to the wellhead 20 and into the plunger receiver 22. Once the plunger 30 is in place in the plunger receiver 22, the control valve 70 can remain open and gas can be produced from the well 100 by allowing it to flow into the outlet line 60. Any fluid brought up the well 100 above the plunger 30 can be discharged out the discharge line 90. The time the control valve 70 is opened is the open cycle 201.

Once the open cycle ends 201 and the control valve 70 is closed, the plunger 30 can be released by the plunger receiver 22 and the weight of the plunger 30 can cause it to drop back down the production tubing 40 to the bottom of the well 100. As the closed cycle 203 continues and the control valve 70 remains closed, the pressure in the well 100 can increase. When the pressure has increased to a sufficient level, the control valve 70 can once again be opened and the open cycle 201 can begin and the plunger 30 can begin to rise to the top of the well 100.

When the plunger lift system 10 is used to produce gas from the well 100, it is desirable to maximize the time the plunger lift system 10 remains in the open cycle 201 so that as much time as possible is spent producing gas from the well 100 during this open cycle 201, but not have the open cycle 201 occur for so long that the well 100 waters in and the well 100 stops flowing gas because the weight of water in the well 100 and the plunger 30 is too great for the pressure of the gas below the plunger 30 to lift the plunger 30 up the well 100.

When the plunger lift system 10 is used to produce oil from the well 100, it is desirable to adjust the time the plunger lift system 10 remains in the closed cycle 203, allowing the plunger 30 to make as many trips as possible up the well 100, bringing up as much water or other fluid as it can carry, but not have the time set so long that too much water is allowed to accumulate on top of the plunger 30 causing the water and the plunger 30 to weigh so much that the pressure of the gas below the plunger 30 cannot lift the plunger 30 and the accumulated water on top of the plunger 30 up the well 100.

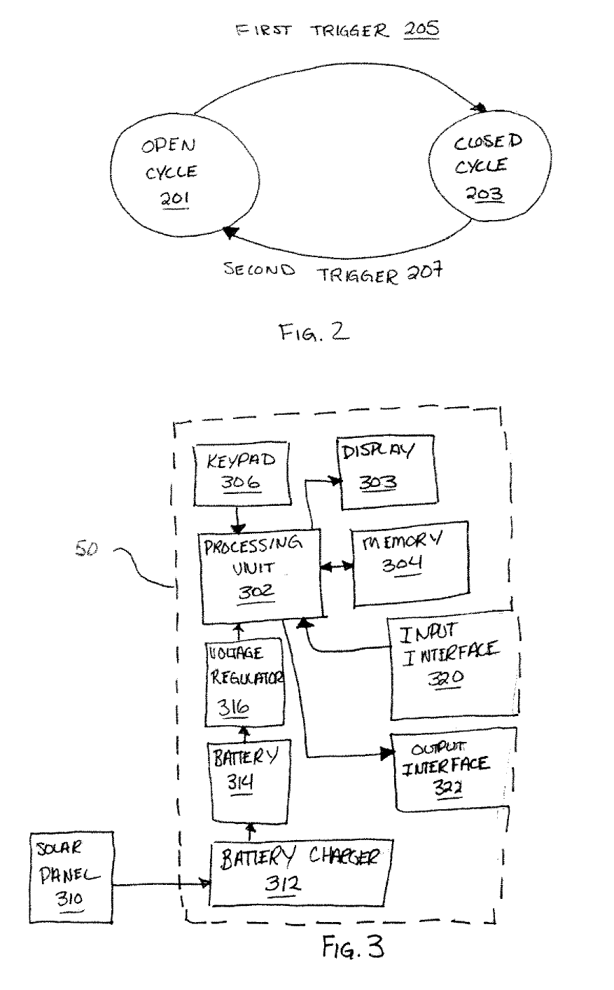

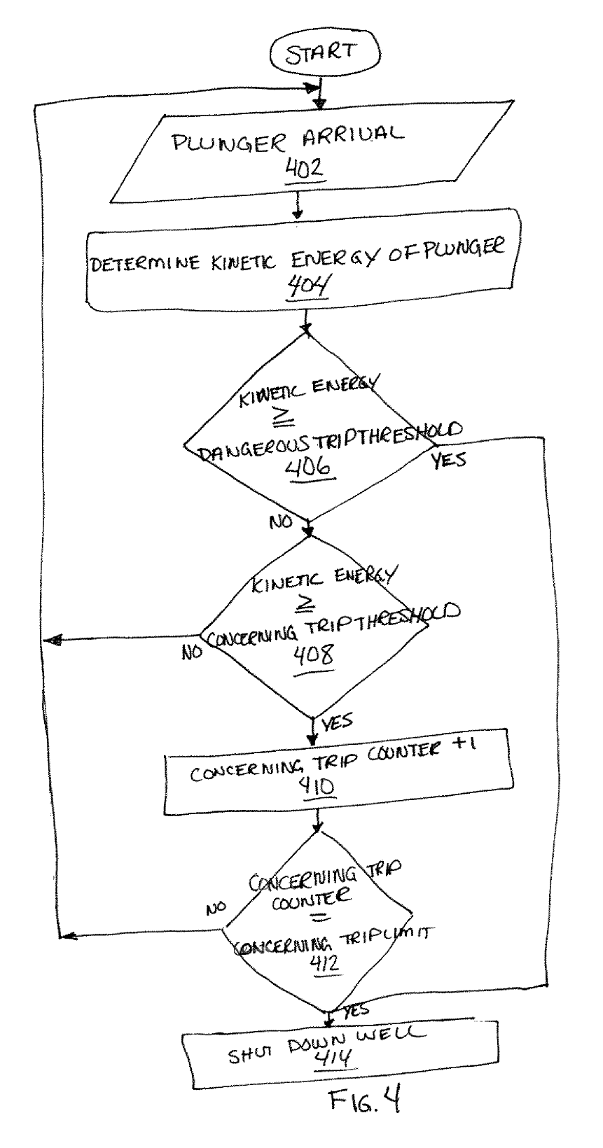

FIG. 3 illustrates a controller 50 that can be used to control the operation of the plunger lift system 10 and alter the operation of the plunger lift system 10 between the open cycle and the closed cycle. Referring again to FIG. 1, the controller 50 can be operably connected to the solenoid 72 so that by sending signals to the solenoid 72 the controller 50 can cause the opening and closing of the control valve 70. The controller 50 can also be operatively connected to the velocity sensor 80 so that the controller 50 can receive output from the velocity sensor 80 that the controller 50 can then use to approximate the speed of the plunger 30 as it passes the velocity sensor 80.

Referring again to FIG. 3, the controller 50 can include a processing unit 302, such a microprocessor that is operatively connected to a computer readable memory 304 and can control the operation of the controller 50. Program instructions for controlling the operation of the processing unit 302 can be stored in the memory 304 as well as any additional data needed for the operation of the controller 50. A keypad 306 and a display 303 can be provided to allow a user to see the settings of the controller 50 and enter inputs and change parameters of the controller 50. An input interface 320 can be provided operatively connected to the processing unit 302 so that the controller 50 can receive signals from external sensors. The velocity sensor 80 can be connected to the input interface 320 to allow signals from the velocity sensor 80 to be transmitted to the controller 50. An output interface 322 can be provided operatively connected to the processing unit 302 to send signals to other devices in the plunger lift system 10. For example, the solenoid 72 attached to the control valve 70 can be connected to the output interface 322 so that the controller 50 can send signals to the solenoid 72.

Because the controller 50 is frequently used in a remote location because the well 100 the controller 50 is being used with is located in a remote location, the controller 50 can be connected to a solar panel 310 that supplies power to controller 50. A battery 314 can be provided to power the processing unit 302 and the battery 314 can be charged with a battery charger 312 connected to the solar panel 310. A voltage regulator 316 can be provided between the processing unit 302 and the battery 314 to provide the proper voltage to the processing unit 302.

The controller 50 can include a weatherproof enclosure for protecting the components of the controller 50 from the elements.

In operation, when the plunger lift system 10 is used to produce gas or other fluids from the well 100, it is desirable to maximize the afterflow time so that as much time as possible is spent producing gas from the well 100 before the control valve 70 is once again closed and the production of gas is temporarily stopped while pressure is once again allowed to build up in the well casing 110. However, the afterflow time cannot be so long that the well 100 will water in and prevent the plunger 30 from rising when the control valve 70 is opened again. At the same time, it is desirable to minimize the close time, simply providing enough time for the plunger 30 to reach the bottom of the well 100 and collect the water that has collected in the bottom of the well 100 before the valve 70 is once again opened and the plunger 30 is used to carry the water to the top of the well 100 so gas can be once again produced from the well 100 during the next afterflow time.

When the control valve 70 of the plunger lift system 10 is opened during its operation to produce gas from well 100, the pressure in the well casing 110 will increase as the plunger 30 rises in the well 100 until the plunger 30 reaches the plunger receiver 22 at the top of the well 100. Once the plunger 30 has reached the plunger receiver 22, the plunger 30 can be held in the plunger receiver 22 while the control valve 70 remains open (either mechanically or by the flow of gas rising up and exiting the well 100) and gas is produced from the well 100 through the outlet line 60. This is the afterflow time. During this afterflow time, the casing pressure will decrease as the gas is allowed to exit the well 100 through the outlet line 60. Eventually the casing pressure will reach a point where it is at its lowest level and after this point the pressure in the casing 110 will start to increase slightly above the lowest point. This increase in the pressure in the casing 110 from its lowest point is caused by fluid once again starting to build up in the well casing 110.

Once the control valve 70 is once again closed after the afterflow time, the pressure in the well casing 110 will once again increase because the gas entering the well casing 110 is prevented from flowing out of the well 100 into the outlet line 60 by the closed control valve 70. The plunger 30 will also be dropped back down the production tubing 40 in the well 100. When the close time is over, the control valve 70 will be opened again and the plunger 30 will once again rise up the well 100 pushed by the gas that has built up in the well 100, starting the cycle all over again.

When the control valve 70 is once again closed and the plunger 30 starts to rise back up the well 100, the fluid that has been allowed to build up in the well 100 before the control valve 70 was closed will be carried up the well 100 on top of the plunger 30. The amount of fluid being carried on top of the plunger 30 and the pressure that has been allowed to build up in the well 100 during the close time will determine the speed of the plunger 30 as it travels back up the well 100. With little fluid on top of the plunger 30, the plunger 30 will travel fast up the well 100. With more fluid on top of the plunger 30, the plunger 30 will travel slower up the well 100 because it has to carry more fluid on top of it.

By carrying the proper amount of fluid on top of the plunger 30 a safe velocity of the plunger 30 as it reaches the top of the well 100 can be achieved. This is very important because if a plunger 30 arrives at the top of the well 100 in the plunger receiver 22 too fast, the impact of the plunger 30 as it arrives in the plunger receiver 22 can damage the wellhead 20 if the impact is too hard. Typically, the plunger receiver 22 that stops the plunger 30 when it reaches the wellhead 20 contains some sort of impact absorber such as a spring, rubber damper, etc. that cushions the impact of the plunger 30 in the plunger receiver 22. However, if the plunger 30 is travelling too fast when it reaches the top of the well 100 and enters the plunger receiver 22, the plunger 30 can hit the top of the plunger receiver 22 too hard and damage the plunger receiver 22 and the wellhead 20.

There are a number of variables in the well 100 that can greatly affect the velocity of the plunger 30 as it reaches the top of the well 100 and cause the plunger 30 to be travelling much faster as it reaches the top of the well 100 than expected. For example, the velocity of the plunger 30 could start out quite low as it starts to rise and then pick up speed as it continues to travel up the well 100. This means the rise time the plunger 30 takes to travel up the well 100 could be quite reasonable, but because the velocity of the plunger 30 started quite low and accelerated as the plunger 30 rose up the well, the velocity of the plunger 30 could be quite high when the plunger 30 reaches the top of the well 100, much higher than would be expected for the time it took the plunger 30 to rise up the well. Additionally, if the pressure of the gas above the plunger 30 as it rises up the well is causing the plunger 30 to slow down during its rise, as the plunger 30 starts to approach the top of the well 100 this will be forced out of the well 100 through the outlet line 60, this sudden removal of the gas could case the plunger 30 to accelerate as it nears the top of the well 100 causing the velocity of the plunger 30 to be higher than expected when it reaches the top of well 100.

This higher than expected velocity of the plunger 30 can not only be caused by unknown conditions in the well 100, the afterflow time or close time being used for the plunger lift system 10 could simply be set wrong or not be ideal for the particular well. Additionally, the conditions in the well 100 can often change over time so even if the afterflow time or close time worked well at one time for the well 100, they may not be ideal at a later time. This can be especially problematically if the controller 50 is not constantly adjusting the afterflow time and/or the close time during the operation of the plunger lift system 10 or if the changes in the well 100 occur relatively quickly and the plunger lift system 10 cannot adjust the afterflow time and/or close time quickly enough to deal with the changing conditions. For example, over time less fluid can be present around the well 100 causing less fluid to enter the well casing 110 during the afterflow time, this will in turn cause less fluid to be carried on top of the plunger 30 as it rises, increasing the velocity of the plunger 30 as it rises up the well 100.

The velocity of the plunger 30 as it reaches the surface can also be slower than expected. For example, the fluid on top of the plunger 30 could cushion the impact of the plunger 30 and slow the velocity of the plunger 30 as it nears the top of the well 100. In this manner, the plunger 30 might be travelling up the well 100 at a higher velocity for most of the trip and then slow down as it nears the top of the well 100 as the fluid on top of the plunger 30 and the pressure of the gas above the plunger 30 slows the plungers 30 trip. This could result in the plunger 30 being allowed to have a faster rise time that might otherwise be considered unsafe because it is slowing down at the top of the well 100 and making a smaller impact than would be expected by the rise time.

Using the velocity sensor 80, the velocity of the plunger 30 as it reaches the top of the well 100 can be determined to try and evaluate if the plunger 30 is moving fast enough to potentially damage the wellhead 20. However, while the velocity of the plunger 30 alone as it reaches the top of the well 100 might be useful to try and determine the likelihood of the plunger 30 damaging the wellhead 20 as it arrives in the plunger receiver 22 it is not very precise and there are a number of unknown variables that can make a person's estimate of a safe velocity imprecise using just the velocity of the plunger 30. The speed the wellhead 20 can handle will depend on the strength of the wellhead 20 and the weight of the plunger 30. While one velocity might be safe for a lighter plunger 30 and/or a stronger wellhead 20, this same velocity might be unsafe for a heavier plunger 30 and/or a weaker wellhead 20.

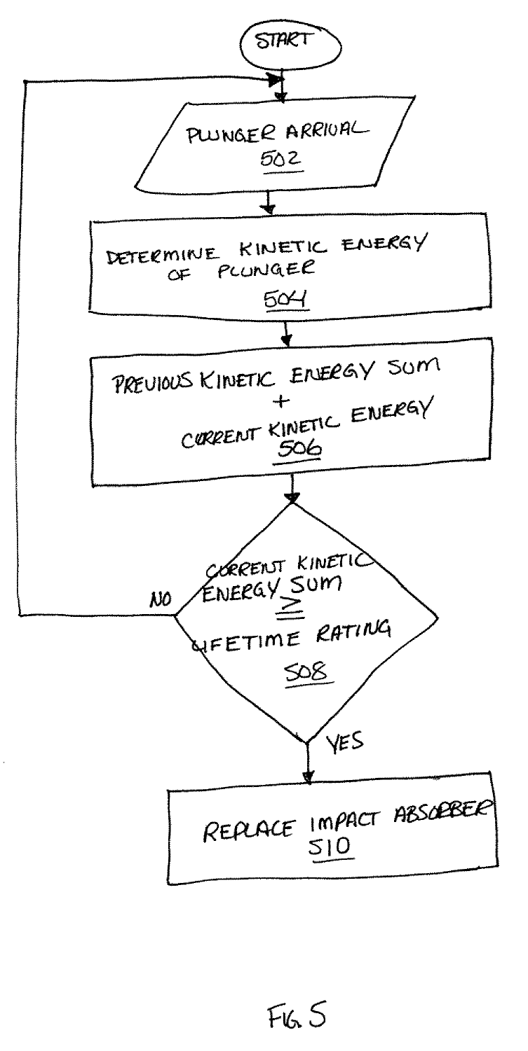

FIG. 4 is a flowchart of a method for dealing with potentially damaging plunger strikes to the wellhead 20. The method can run while the plunger lift system 20 is being used to produce gas or some other fluid from the well 100 and monitor the kinetic energy of the plunger 30 as it reaches the top of the well 100.

The method can start and wait until the plunger 30 is sensed by the velocity sensor 80 passing the velocity sensor 80 as it reaches the top of the well 100 at step 402. This sensing of the plunger 30 arriving at the top of the well 100 will also have the velocity sensor 80 measuring a velocity of the plunger 30 as it passes the velocity sensor 80.

Once step 402 has occurred and the velocity of the plunger 30 has been measured, the method can move onto step 404 and the measured velocity of the plunger 30 can be used to approximate the kinetic energy of the plunger 30 as it is arriving at the top of the well 100. Using the weight or mass of the plunger 30 and the velocity measured by the velocity sensor 80, the kinetic energy of the plunger 30 as it reaches the top of the well 100 can be approximated.

Plungers can vary widely in shape, size and the material that they are made from and as a result the weight or mass of different types of plungers can also vary quite significantly. If the method was only measuring the velocity of the plunger 30 as it reaches the top of the well 100 and trying to determine if the measured surface velocity of the plunger 30 was high enough to damage or potentially damage the wellhead 20 a velocity threshold might be used by the controller 50 that is chosen because it works for the average weight of a number of different types of plungers and is low enough not to damage a typically wellhead. However, while a light plunger might not cause any damage if it arrives at the top of the wellhead 20 below or even above the dangerous velocity threshold, this dangerous velocity threshold may not be sufficient for a heavier plunger that might cause damage even if the plunger has a velocity below the dangerous velocity threshold when it reaches the top of the well 100 because of the plunger's greater mass. By using the measured velocity of the plunger and determining a kinetic energy of the plunger 30 using the mass of the plunger 30, different weights of plungers are taken into account.

With the approximated kinetic energy, the method can move onto step 406 and this kinetic energy can be compared to a dangerous trip of the specific wellhead 20 and the plunger receiver 22 used by the plunger lift system 10. The dangerous trip threshold will typically be provided by a manufacturer or supplier of the wellhead 20 equipment. The strength of the wellhead 20 equipment can vary between manufacturers and even the specific configuration of the wellhead 20. For example, some plunger receivers 22 contain springs as an impact absorber while others contain rubber dampers. Whether a spring or rubber damper is used can affect the amount of impact that can be sustained by the plunger receiver 22. Additionally, even if two plunger receivers 22 both use either a spring or a rubber damper, the spring or rubber damper used can vary greatly in their strength and therefore vary in how much of an impact they can sustain. By setting a generic dangerous trip threshold that is mean to be used with a range of possible wellheads and not specifically the wellhead 20 used in a specific plunger lift system 10, if the wellhead 20 is not as strong as the average strength that is assumed, the wellhead 20 could be damaged even if the velocity of the plunger hitting it is below the set generic dangerous trip threshold. However, likely what is more commonly going to happen is that a generic dangerous trip threshold will be set unnecessarily low to build in a safety factor that allows it to be used with a wide range of wellheads with a range of strengths including weaker wellheads. This could mean that strong wellhead configurations that could allow for faster plunger 30 trips may not be fully utilized because the dangerous trip threshold is set unnecessarily low to allow weaker wellhead 20 configurations to be used and this in turn could lead to the plunger lift system 10 not be operated as efficiently as it could with the strong wellhead 20.

At step 406 the controller 50 can determine if the kinetic energy of the plunger 30 as it arrives at the top of the well 100 is lower than the dangerous trip threshold or whether it is equal to or greater than it. This dangerous trip threshold can be an amount of kinetic energy that has been determined by the manufacturer that is likely to cause imminent damage to the wellhead 20 if the wellhead 20 is impacted even once more with this much kinetic energy (if damage has not already occurred from the first impact). If at step 406 it is determined that the plunger 30 has arrived in the plunger receiver 22 with kinetic energy that is equal to or greater than the dangerous trip threshold, the controller 50 can move onto step 414 and stop the operation of the plunger lift system 10. By shutting down the plunger lift system 10 and the production of gas from the well 100 any additional dangerous trips of the plunger 30 can be stopped. An operator of the well 100 can then reset the well 100 and make the changes necessary to the operation of the plunger lift system 10 to try and prevent dangerous rise times before restarting the plunger lift system 10 and once again producing gas from the well 100.

Alternatively, if at step 406 it is determined that the kinetic energy of the plunger 30 is less than the dangerous trip threshold, the controller 50 can move on to step 408 of the method and see if the measured velocity results in the plunger 30 having enough kinetic energy causing it to be greater to or equal to a concerning trip threshold.

While the kinetic energy of the plunger 30 represented by the concerning trip threshold is lower than the dangerous trip threshold and should not be high enough to cause imminent damage to the wellhead 20, a number of repeated impacts of the plunger 30 with this amount of kinetic energy or higher will likely still damage the wellhead 20. Again, in order to take into account a specific wellhead 20 and its configuration, the concerning trip threshold will typically be provided by the manufacturer of the wellhead 20 and specific to the particular wellhead 20 and configuration being used. The manufacturer of the wellhead 20 can also specify a number of safe impacts that the wellhead 20 can sustain at or above the concerning trip threshold.

If a step 408 it is determined that the kinetic energy of the plunger 30 arriving at the top of the well 100 is below the concerning trip threshold, the method can return to step 402 and wait for the velocity sensor 80 to once again measure the plunger 30 arriving at the top of the well 100 and the method can then repeat when the velocity of the plunger 30 is once again measured arriving at the top of the well 100.

However, if at step 408 it is determined that based on the measured velocity of the plunger 30, the plunger 30 has kinetic energy equal to or greater than the concerning trip threshold (the method will already have moved past step 406 so the kinetic energy of the plunger 30 will be less than the dangerous trip threshold), the controller 50 can move on to step 410 and count the trip of the plunger 30 with a concerning trip counter. The concerning trip counter will be an indicator of the number of times the plunger 30 has arrived at the top of the well 100 with kinetic energy that is equal to or above the concerning trip threshold, but below the dangerous trip threshold.

At step 412 the method can see if the concerning trip counter is equal to a concerning trip limit. The concerning trip limit can be the number of trips that are acceptable for the plunger 30 to arrive at the top of the well 100 having kinetic energy at or above the concerning trip threshold but below the dangerous trip threshold. This number can be pre-set in the controller 50 with a number such as 3 or it can specified by the manufacturer of the wellhead 20. If at step 412 it is determined that the concerning trip limit has not been reached, the method can return to step 402 and wait for the velocity sensor 80 to once again determine the plunger 30 is approaching the top of the well 100 and measure its velocity. However, if at step 410 it is determined that the concerning trip count is equal to the concerning trip limit, the method can move onto step 414 and shut down the plunger lift system 10 and stop producing from the well 100 until an operator can look at what is happening and restart the plunger lift system 10.

In this manner, method will continue to monitor the kinetic energy of the plunger 30 each time it arrives at the wellhead 20 and if the kinetic energy is always safe (below the dangerous trip threshold and the concerning trip threshold) the plunger lift system 10 will operate normally. However, if the kinetic energy of the plunger 30 is above the dangerous trip threshold the plunger lift system 10 will immediate be shut down and if the kinetic energy of the plunger 30 is below the dangerous trip threshold but above the concerning trip threshold a predetermined number of times the plunger lift system will also be shut down. This can protect the equipment of the wellhead 20 from being damaged from being impacted by a too fast moving plunger 30, yet by using the kinetic energy and the thresholds determined for the particular wellhead 20 being used and its configuration the method can allow more accurate dangerous impacts to be determined potentially preventing the plunger lift system 10 from operating less efficiency because the thresholds are set too low to accommodate a wide range of wellhead 20 equipment and plungers 30.

In addition to determining the kinetic energy of the plunger 30 as it arrives at the top of the well 100 in order to try and prevent dangerous impacts of the plunger 30 to the wellhead 20, the kinetic energy can be determined and used in order to try and allow more efficient maintenance of the plunger lift system 10 to be performed. By calculating the kinetic energy of the plunger 30 each time it arrives at the top of the well 100 and summing this kinetic energy as the plunger lift system 10 is in operation, a sum of the kinetic energy can be kept to see how much kinetic energy the wellhead 20 and more commonly an impact absorber, such as a spring, rubber damper, etc. installed in the plunger receiver 22 has absorbed over the life of the impact absorber to determine when the impact absorber should be replaced.

Currently, most operators of a plunger lift system 10 use a set time interval to determine when to do maintenance on a wellhead 20 (typically replacing the impact absorber in the wellhead receiver 22 that the plunger 30 impacts against). For example, ever six months the plunger lift system 10 is shut down and the impact absorber in the plunger receiver 22 is replaced with a new impact absorber. The idea behind this time based change interval is to choose a length of time where the impact absorber should last without failing, but is usually short enough to ensure a decent safety factor. This means that if the plunger lifts system 10 is operating in a manner where the plunger 30 impacts in the plunger receiver 22 against the impact absorber are relatively low or there are few hard impacts, a six month change interval may be sooner than necessary for replacing the impact absorber. In this case, the impact absorber may safely last eight months or more. Alternatively, if the plunger 30 has a number of hard impacts against the impact absorber during the operation of the plunger lift system 10 or the plunger 30 is regularly impacting the impact absorber harder than expected, the impact absorber may have absorbed more kinetic energy than expected and the impact absorber might fail prematurely. In this case, the impact absorber might fail after only four months instead of the six month replacement interval being used. This could cause the plunger lift system 10 to have to be stopped and an unscheduled maintenance trip be made to replace the failed impact absorber early than the planned time interval. Alternatively, if an operator does not figure out that the impact absorber has failed earlier than the schedule replacement interval, the plunger lift system 10 could continue to operate with plunger 30 impacting against the failed impact absorber causing damage to the wellhead 20.

FIG. 5 illustrates a method of approximating the amount of kinetic energy that has been absorbed by an impact absorber meant to absorb the impact of the plunger 30 such as a spring, rubber damper, etc. in the wellhead 20 during the operation of the plunger lift system 10 so that the impact absorber can be replaced when the amount of kinetic energy it has absorbed reaches a lifetime rating for the impact absorber regardless of the amount of time the plunger lift system 10 has been in operation with that impact absorber. The method shown in FIG. 5 could be performed simultaneously with the method shown in FIG. 4 although it would be possible to perform only one of the methods and not the other.

The method can start and wait until the plunger 30 is sensed by the velocity sensor 80 passing the velocity sensor 80 as it reaches the top of the well 100 at step 502. This sensing of the plunger 30 arriving at the top of the well 100 will also have the velocity sensor 80 measuring a velocity of the plunger 30 as it passes the velocity sensor 80.

Once step 502 has occurred and the velocity of the plunger 30 has been measured, the method can move onto step 504 and the measured velocity of the plunger 30 can be used to approximate the kinetic energy of the plunger 30 as it is arriving at the top of the well 100. Using the weight or mass of the plunger 30 and the velocity measured by the velocity sensor 80, the kinetic energy of the plunger 30 as it reaches the top of the well 100 can be approximated.

With the approximated kinetic energy determined at step 504, the method can move onto step 506 and this currently determined kinetic energy can be added to a kinetic energy sum to determine a current kinetic energy sum. This kinetic energy sum can be a total amount of kinetic energy the impact absorber has absorbed since it was installed in the wellhead 20. For example, when the impact absorber is first installed in the plunger receiver 22 the kinetic energy sum will be 0 since it has not yet absorbed any impacts by the plunger 30. However, when the plunger 30 arrives for the first time in the wellhead 20 the kinetic energy determined at step 504 will become the first kinetic energy sum. As the plunger 30 repeatedly arrives in the wellhead 20 and the kinetic energy of each arrival is determined, the kinetic energy of each arrival will keep being added to the kinetic energy sum and this kinetic energy sum will continue to increase as the plunger lift system 10 continues to operate.

After the currently calculated kinetic energy of the arriving plunger 30 has been added to the previous kinetic energy sum at step 506, the method can move onto step 508 and compare the current kinetic energy sum (including the most recent plunger 30 arrival) to a lifetime rating for the impact absorber to see if it is equal to or greater than the lifetime rating. This lifetime rating can be an indicator of how much kinetic energy the particular impact absorber can absorb over its lifetime before it is likely to fail. Typically this lifetime rating that the impact absorber can absorb over its lifetime before failure is provided by the manufacturer. Once the current kinetic energy sum is as high as this lifetime rating (or slightly higher), it is likely that the impact absorber will soon fail.

If at step 508 it is determined that the current kinetic energy sum is less than the lifetime rating, the method can return to step 502 and await the next arrival of the plunger 30 to measure its velocity and calculate the kinetic energy of this next arrival at step 504 again. The method will then repeat steps 506, 508 and 510, if necessary, before returning to step 502 and waiting for the next arrival of the plunger 30.

Alternatively, if at step 508 it is determined that the current kinetic energy sum is equal to or greater than the lifetime rating, this means that the impact absorber has absorbed the total amount of kinetic energy that it can reliably absorb and is in danger of failing. The method can then move onto step 510 so that the impact absorber can be replaced. Typically, the plunger lift system 10 is stopped so the wellhead 20 can be removed and the impact absorber replaced with a new impact absorber. With the new impact absorber in place, the current kinetic energy sum will once again be set to 0 and the plunger lift system 10 can be restarted and operated with the new impact absorber until the kinetic energy sum once again reaches the lifetime rating for the new impact absorber.

The method shown in FIG. 5 will repeatedly approximate the kinetic energy of each arrival of the plunger 30 in the wellhead 20 and continue adding it up until it reaches the lifetime rating. The impact absorber can then be replaced with a new impact absorber and the plunger lift system 10 restarted. In this manner, rather than simply replacing the impact absorber at a set time interval (e.g. 6 months), if the impact absorber has been subjected to few hard impacts or overall lower impacts than expected, the impact absorber may last longer than expected and take longer than this set time interval method shown in FIG. 5 indicates that impact absorber should be replaced (e.g. 8 months). This can reduce the cost of replacement impact absorbers since fewer may be needed and reduce the downtime of the well 100 as the plunger lift system 10 is shut down and the impact absorber replaced less often. However, if the plunger 30 has a number of relatively hard impacts or the plunger 30 is repeatedly impacting the top of the well 100 harder than expected, the potential damage to the wellhead 20 that can occur if the impact absorber were to prematurely fail before the replacement time interval can be avoided using this method.

Additionally, the method does not necessarily have to simply be run until the lifetime rating is reached and the plunger lift system 10 is shut down to replace the impact absorber. The current kinetic energy sum can be displayed to an operator at any time during the operation of the plunger lift system 10 to allow an operator to see the current kinetic energy sum and more importantly to see how close the current kinetic energy sum is to the lifetime rating. This will allow an operator to quickly see how much life is left in the impact absorber in a plunger lift system 10 and given them an idea of how long before the impact absorber must be replaced. This can allows the operator to proactively plan for schedule maintenance of the plunger lift system 10 even though a set time interval for replacing the impact absorber is not being used.

The foregoing is considered as illustrative only of the principles of the invention. Further, since numerous changes and modifications will readily occur to those skilled in the art, it is not desired to limit the invention to the exact construction and operation shown and described, and accordingly, all such suitable changes or modifications in structure or operation which may be resorted to are intended to fall within the scope of the claimed invention.

1. A method of operating a plunger lift system in a well, the method comprising:
in response to a plunger passing a velocity sensor positioned proximate a top of the well, measuring a plunger velocity using the velocity sensor;
using the measured plunger velocity to determine a kinetic energy of the plunger as it passes the velocity sensor;
if the determined kinetic energy of the plunger exceeds a dangerous trip threshold, shutting down the plunger lift system; and
repeating the steps of the method each time the plunger passes the velocity sensor.

2. The method of claim 1 wherein the kinetic energy is determined using a mass of the plunger and the measured plunger velocity.

3. The method of claim 1 wherein the dangerous trip kinetic threshold is specific to a well head used in the plunger lift system.

4. The method of claim 1 further comprising shutting down the plunger lift system if the determined kinetic energy of the plunger passing the velocity sensor exceeds a concerning trip threshold a predetermined number of times.

5. The method of claim 4 wherein the concerning trip threshold is less than the dangerous trip threshold.

6. The method of claim 4 wherein the predetermined number of times is 2 of more.

7. The method of claim 4 wherein the predetermined number of times is 3 or more.

8. The method of claim 4 wherein the concerning trip threshold is specific to a well head used in the plunger lift system.

9. A controller for controlling the operation of a plunger lift system for a well having a plunger, a plunger velocity sensor, and a control valve between the well and an outlet line, the controller comprising:
at least one processing unit;
an input interface operatively connectable to the plunger velocity sensor; and
at least one memory containing program instructions, the at least one processing unit responsive to the program instructions and operative to perform a method comprising:
in response to the plunger passing the velocity sensor positioned proximate a top of the well, measuring a plunger velocity using the velocity sensor;
using the measured plunger velocity to determine a kinetic energy of the plunger as it passes the velocity sensor;
if the determined kinetic energy of the plunger exceeds a dangerous trip threshold, shutting down the plunger lift system; and
repeating the steps of the method each time the plunger passes the velocity sensor.

10. The controller of claim 9 wherein the kinetic energy is determined using a mass of the plunger and the measured plunger velocity.

11. The controller of claim 9 wherein the dangerous trip kinetic threshold is specific to a well head used in the plunger lift system.

12. The controller of claim 9 further comprising shutting down the plunger lift system if the determined kinetic energy of the plunger passing the velocity sensor exceeds a concerning trip threshold a predetermined number of times.

13. The controller of claim 12 wherein the concerning trip threshold is less than the dangerous trip threshold.

14. The controller of claim 12 wherein the predetermined number of times is 2 of more.

15. The controller of claim 12 wherein the predetermined number of times is 3 or more.

16. The controller of claim 12 wherein the concerning trip threshold is specific to a well head used in the plunger lift system.

17. A plunger lift system for removing fluids from a well, the system comprising:
a wellhead provided at a top of the well and having a plunger receiver;
production tubing connected to the well head and extending downwards down the well, the plunger receiver operatively connected to a top end of the production tubing;
a plunger provided in the production tubing;
an outlet line connected to the well head below the plunger receiver and fluidly connected with the production tubing;
a control valve connected inline with the outlet line;
a plunger velocity sensor positioned on the outside of the plunger receiver to detect the plunger; and
a controller operatively connected to the plunger velocity sensor to receive information from the plunger velocity sensor and operatively connected to the control valve to open and close the control valve, the controller operative to perform a method comprising:
opening a control valve and allowing the plunger to rise to a top of the well;
in response to the plunger passing the velocity sensor positioned proximate a top of the well, measuring a plunger velocity using the velocity sensor;
using the measured plunger velocity to determine a kinetic energy of the plunger as it passes the velocity sensor;
if the determined kinetic energy of the plunger exceeds a dangerous trip threshold, shutting down the plunger lift system;
after an afterflow time has passed closing the valve and allowing the plunger to fall to a bottom of the well;
after a period of time has passed, opening the valve and allowing the plunger to rise to the top of the well; and
repeating the steps of the method each time the plunger passes the velocity sensor.

18. The plunger lift system of claim 17 wherein the kinetic energy is determined using a mass of the plunger and the measured plunger velocity.

19. The plunger lift system of claim 17 wherein the dangerous trip kinetic threshold is specific to the well head.

20. The plunger lift system of claim 17 further comprising shutting down the plunger lift system if the determined kinetic energy of the plunger passing the velocity sensor exceeds a concerning trip threshold a predetermined number of times.

21. The plunger lift system of claim 17 wherein the concerning trip threshold is less than the dangerous trip threshold.

22. The plunger lift system of claim 20 wherein the predetermined number of times is 2 of more.

23. The plunger lift system of claim 20 wherein the predetermined number of times is 3 or more.

24. The plunger lift system of claim 20 wherein the concerning trip threshold is specific to the well head.

25. A method of determining kinetic energy in a plunger lift system in a well, the method comprising:
in response to a plunger passing a velocity sensor positioned proximate a top of the well, measuring a plunger velocity using the velocity sensor; and
using the measured plunger velocity to determine a kinetic energy of the plunger as it passes the velocity sensor.

26. A method of operating a plunger lift system in a well, the method comprising:
measuring a velocity of a plunger using a velocity sensor positioned proximate a top of the well;
using the measured velocity of the plunger to determine a kinetic energy of the plunger as it passes the velocity sensor;
repeating the steps of the method each time the plunger passes the velocity sensor;
each time the plunger passes the velocity sensor and a kinetic energy of the plunger is determined, summing the kinetic energy to determine a current kinetic energy sum; and
when the current kinetic energy sum is greater or equal to a lifetime rating, replacing an impact absorber in a well head of the plunger lift system.

27. The method of claim of claim 26 wherein the current kinetic energy sum starts at 0 before the plunger passes the velocity sensor for a first time.

28. The method of claim of claim 26 wherein the impact absorber is one of: a spring; and rubber damper.

29. The method of claim of claim 26 wherein the lifetime rating is specific to a well head in the plunger lift system.

30. A controller for controlling the operation of a plunger lift system for a well having a plunger, a plunger velocity sensor, and a control valve between the well and an outlet line, the controller comprising:
at least one processing unit;
an input interface operatively connectable to the plunger velocity sensor; and
at least one memory containing program instructions, the at least one processing unit responsive to the program instructions and operative to perform a method comprising:
measuring a velocity of a plunger using a velocity sensor positioned proximate a top of the well;
using the measured velocity of the plunger to determine a kinetic energy of the plunger as it passes the velocity sensor;
repeating the steps of the method each time the plunger passes the velocity sensor;
each time the plunger passes the velocity sensor and a kinetic energy of the plunger is determined, summing the kinetic energy to determine a current kinetic energy sum; and
when the current kinetic energy sum is greater or equal to a lifetime rating, creating a signal that indicates replacing an impact absorber in a well head of the plunger lift system.

31. The controller of claim 30 wherein the current kinetic energy sum starts at 0 before the plunger passes the velocity sensor for a first time.

32. The controller of claim 30 wherein the impact absorber is one of: a spring; and rubber damper.

33. The controller of claim 30 wherein the lifetime rating is specific to a well head in the plunger lift system.

34. A plunger lift system for removing fluids from a well, the system comprising:
a wellhead provided at a top of the well and having a plunger receiver, the plunger receiving having an impact absorber;
production tubing connected to the well head and extending downwards down the well, the plunger receiver operatively connected to a top end of the production tubing;
a plunger provided in the production tubing;
an outlet line connected to the well head below the plunger receiver and fluidly connected with the production tubing;
a control valve connected inline with the outlet line;
a plunger velocity sensor positioned on the outside of the plunger receiver to detect the plunger; and
a controller operatively connected to the plunger velocity sensor to receive information from the plunger velocity sensor and operatively connected to the control valve to open and close the control valve, the controller operative to perform a method comprising:
opening a control valve and allowing the plunger to rise to a top of the well;
in response to the plunger passing the velocity sensor positioned proximate a top of the well, measuring a plunger velocity using the velocity sensor;
using the measured plunger velocity to determine a kinetic energy of the plunger as it passes the velocity sensor;
after an afterflow time has passed closing the valve and allowing the plunger to fall to a bottom of the well;
after a period of time has passed, opening the valve and allowing the plunger to rise to the top of the well;
repeating the steps of the method each time the plunger passes the velocity sensor;
each time the plunger passes the velocity sensor and a kinetic energy of the plunger is determined, summing the kinetic energy to determine a current kinetic energy sum; and
when the current kinetic energy sum is greater or equal to a lifetime rating, creating a signal that indicates replacing the impact absorber.

35. The plunger lift system of claim 34 wherein the current kinetic energy sum starts at 0 before the plunger passes the velocity sensor for a first time.

36. The plunger lift system of claim 34 wherein the impact absorber is one of: a spring; and rubber damper.

37. The plunger lift system of claim 34 wherein the lifetime rating is specific to a well head in the plunger lift system.
